(19) United States
(12) Patent Application Publication
(10) Pub. No.: US 2005/0072725 A1
(43) Pub. Date: Apr. 7, 2005

(54) Inline water filter

(76) Inventor: Phillip A. Swanson, Glenview, IL (US)

Correspondence Address: JOHN C SHEPARD, 575 SUNSET ROAD, WINNETKA, IL, 60093, US

(21) Appl. No.: 10/800,545

(22) Filed: Mar. 15, 2004

Related U.S. Application Data
(60) Provisional application No. 60/455,678, filed on Mar. 19, 2003.

(51) Int. Cl. B01D 27/02; B01D 27/14

(52) U.S. Cl. 210/289; 210/316; 210/317; 210/335; 210/449

(57) ABSTRACT

An inline water filter includes flexible inlet and outlet connecting tubes and an intermediate filter body joined together by a pair of dual-diameter connecting fittings defining a flow passageway therethrough. Filter media is disposed within the filter body and within enlarged sections of the fittings. The connecting tubes are held onto the barbed fittings by ferrules crimped thereover and have connectors at their free ends for attachment to a fluid source and a fluid delivery point.

### CROSS-REFERENCE TO RELATED APPLICATIONS

This application claims the benefit of Provisional Patent Application Ser. No. 60/455,678, filed Mar. 19, 2003.

### BACKGROUND OF THE INVENTION

1. Technical Field

This invention relates generally to an inline filter and, more particularly, to an inline filter adapted for use along a water supply line.

2. Background Art

In the prior art, water filters are well-known. Water filters can be employed to physically remove solid matter or suspended impurities, such as particulate or sediment. Filters can also be employed to chemically remove dissolved materials or impurities and remove bad tastes or smells. Filters can also be designed to remove biological agents to minimize disease.

Also well-known are flexible supply lines which provide a final connection between conventional house plumbing and a faucet. However, most filters in the prior art are rigid and are connected to the water supply by rigid piping which is cut, fitted, threaded, flared, or otherwise adapted to existing plumbing. Such systems and processes are not inexpensive as they involve unnecessary costs both in materials and installation. Further, they cannot easily be removed or replaced by a typical homeowner.

To ease installation, filters have been designed which are mounted to the ends of faucet nozzles by way of the internal threads present to attach aerators. However, because of their placement, these filters are limited in size and often are generally obtrusive to using the faucet. Also, they do not provide protection for washers or o-ring seals.

The following United States patents are representative of the prior art and illustrate filters that have been previously employed with water supply lines.

Mizrahi U.S. Pat. No. 6,494,325 shows a toilet water-line filter in which a mesh straining element is positioned within a housing which may be threaded by means of external wings intermediate the toilet fill valve and a flexible supply line.

Schilling U.S. Pat. No. 758,150 shows a straining device attachable to a water inlet pipe with a two-part strainer having a wire screen of coarse mesh and one downstream of very fine mesh. The nipples at the inlet and outlet ends are provided with ordinary unions to allow connection along the water line.

Gilbert U.S. Pat. No. 5,223,136 and Scrogham et al. U.S. Pat. No. 5,992,643 show filters which are mounted within rigid elongate pipes that are attached inline with supply lines.

Movshovits U.S. Pat. No. 4,604,202 discloses a mesh-type filter which may be threaded onto the end of a faucet or nozzle.

Turetsky U.S. Pat. No. 4,178,250 shows a filter-purifier cartridge having a hollow core containing purifying medium and a surrounding filter element with fluid passing through the purifier medium and the filter element.

Collin U.S. Pat. No. 948,311 shows a water strainer attachable to the helical threads of a conventional outdoor faucet or bib.

Hendrix U.S. Pat. No. 4,609,459 discloses a filter apparatus, having a hollow, T-shaped, rigid body, which may be connected along a water line and has filter elements which may be interchanged or replaced.

The use of flexible hoses with filters are shown in Hunter et al. U.S. Pat. No. 3,685,657 wherein the fabric covering acts as a strainer and Justice U.S. Pat. No. 5,078,862 wherein a lint trap filter is employed in a washing machine drain hose.

### BRIEF SUMMARY OF THE INVENTION

The present invention is directed to overcoming one or more of the problems as set forth above.

It is a general object of the present invention to provide a new and improved inline water filter.

It is another object of the present invention to provide a inline water filter which is simple, compact and inexpensive, yet is a convenient and reliable item.

It is an additional object of the present invention to provide an inline water filter which is easily installed and replaced as a single, self-contained unit and functions as a connecting supply line between a water pipe and a faucet or toilet and which can be made in a variety of sizes and configurations.

It is an further object of the present invention to provide an inline water filter which is easily constructed from common or standard plumbing items.

In an exemplary embodiment of the invention, an inline water filter includes flexible inlet and outlet connecting tubes and an intermediate flexible filter body joined together by a pair of connecting fittings defining a flow passageway therethrough. Filter media is located within the filter body and within an enlarged section of the passageway of the fittings.

In another embodiment of the invention, the inline filter has small diameter inlet and outlet connecting tubes and a larger diameter filter body. The connecting fittings have a large diameter proximal portion for insertion into the filter body and a small diameter distal stem portion for insertion into the connecting tubes. The passageways defined through the fittings have a small opening at the distal stem portion and a large opening at the proximal end allowing for a large surface area to reduce clogging at the ends of the filter media.

In yet another embodiment of the invention, the fittings have barbs at their opposed ends and the connecting tubes are held thereon by ferrules crimped thereover and have connectors at their free ends for attachment respectively to a fluid source and a fluid terminus.

In a preferred embodiment of the invention, the inline filter includes a series of filter media so that the filter is multi-stage to filter out a variety of unwanted impurities, particulates and chemicals. The filter media is carried by the filter body and by the connecting fittings.

### BRIEF DESCRIPTION OF THE SEVERAL VIEWS OF THE DRAWINGS

The details of construction and operation of the invention are more fully described with reference to the accompanying drawings which form a part hereof and in which like reference numerals refer to like parts throughout.

In the drawings:

FIG. 1 is a front view of a first embodiment of an inline filter constructed in accordance with the present invention exploded from an upstream fluid source and a downstream delivery system;

FIG. 2 is an enlarged, partial, cross-sectional view of the inline filter shown in FIG. 1 taken along its longitudinal axis;

FIG. 3 is an enlarged, cross-sectional view of the inline filter taken along line 3-3 of FIG. 1;

FIG. 4 is an enlarged, cross-sectional view of the inline filter taken along line 4-4 of FIG. 1;

FIG. 5 is an enlarged, perspective view of the dual barb fitting showing the counterbore at one end;

FIG. 6 is an enlarged, cross-sectional view of a second embodiment of an inline filter constructed in accordance with the present invention;

FIG. 7 is an enlarged, cross-sectional view of a third embodiment of an inline filter constructed in accordance with the present invention;

FIG. 8 is an enlarged, cross-sectional view of a fourth embodiment of an inline filter constructed in accordance with the present invention; and,

FIG. 9 is an enlarged, cross-sectional view of a fifth embodiment of an inline filter constructed in accordance with the present invention.

### DETAILED DESCRIPTION OF THE INVENTION

Best Modes for Carrying Out the Invention

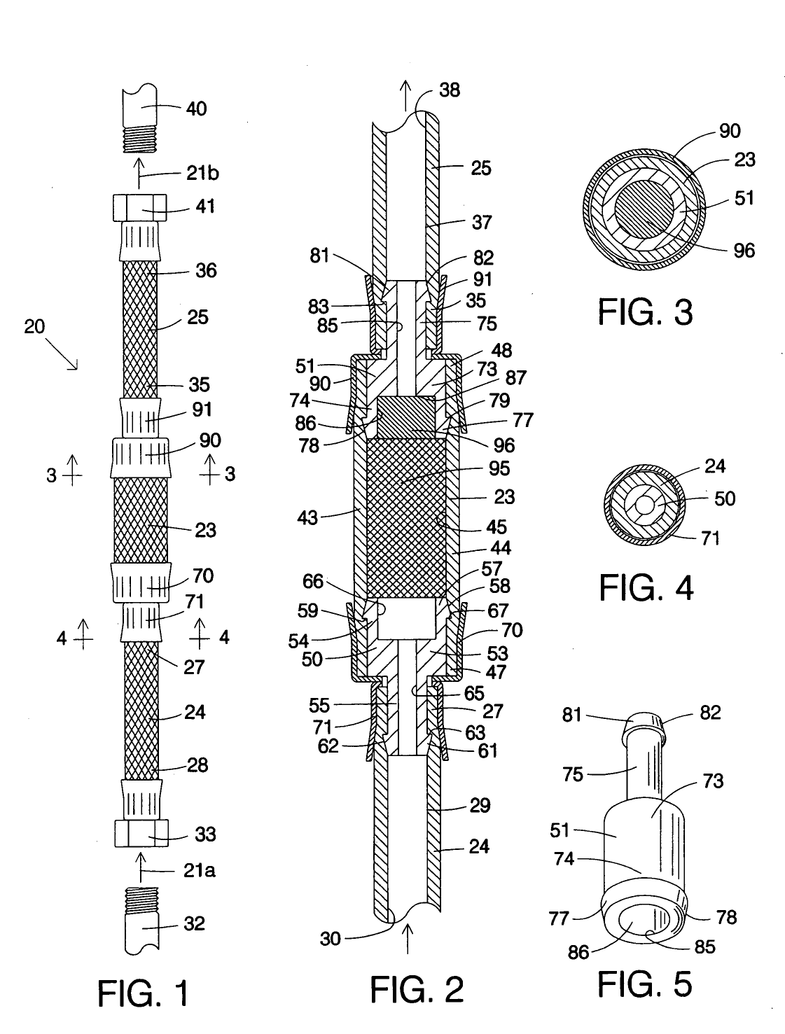

Referring to the drawings, particularly FIGS. 1 through 5, a first embodiment of an inline water filter, generally designated 20, for filtering water flowing in the direction indicated by the arrows 21a and 21b is seen to include a filter body 23, an inlet tube 24 and an outlet tube 25.

The elongate flexible connecting inlet tube 24 has a proximal end 27 and a distal end 28 and a side wall 29 defining a longitudinal flow passage 30 therebetween. The inlet tube 24 has a female connector at its distal end adapted for attachment to an upstream source of fluid indicated by the externally threaded pipe 32 by means of a hex nut 33 or other connecting means.

The elongate flexible connecting outlet tube 25 has a proximal end 35 and a distal end 36 and a side wall 37 defining a longitudinal flow passage 38 therebetween. The outlet tube 25 has a female connector at its distal end adapted for attachment to a downstream fluid delivery point or system indicated by an externally threaded pipe 40 by means of a hex nut 41 or other connecting means. The internal diameter of the inlet and outlet tubes 24 and 25 is about 0.3 inch and the external diameter about 0.5 inch.

The filter body 23 includes an elongate flexible hollow tube 43 having a side wall 44 defining a flow passage 45 along a longitudinal axis with an upstream inlet and a downstream outlet at respective ends 47 and 48 spaced along the longitudinal axis. The filter body 23 has an internal diameter greater than the internal diameters of the inlet and outlet tubes 24 and 25. Typically, the internal diameter of the filter body 23 is about 0.75 inch and the external diameter about 1 inch.

A pair of dual-diameter barbed fittings 50 and 51 connect the filter body 23 to and between the inlet and outlet connecting tubes 24 and 25. The upstream inlet fitting 50 connects the inlet tube proximal end 27 to the hollow tube 43 at its upstream end and includes a body 53 having a downstream large diameter proximal end portion 54 and an upstream small diameter distal stem end portion 55. The fitting proximal end portion 54 has an outer surface and a radially-extending circumferential external rib, or barb 57, projecting from the outer surface including a tapered camming surface 58 facing toward the downstream proximal end and a shoulder 59 facing toward the upstream distal end. The hollow tube inlet end 47 is slidably positioned over the fitting proximal end portion 54 and the camming surface 58 with the barb 57 internally engaging the hollow tube side wall 44 to limit relative longitudinal movement of the parts and frictionally hold the hollow tube 43 in position thereon. The fitting distal end portion 55 has an outer surface and a radially-extending circumferential external barb 61 projecting from the outer surface including a tapered camming surface 62 facing toward the upstream distal end and a shoulder 63 facing toward the downstream proximal end. The inlet tube proximal end 27 is slidably positioned over the camming surface 62 and the fitting distal portion 55 with the barb 61 internally engaging the inlet tube side wall 29 to limit relative longitudinal movement of the parts and frictionally hold the inlet tube 24 in position thereon. The inlet and outlet fittings 50 and 51 may be made of brass, plastic, or any other suitable material.

The inlet fitting 50 defines a passageway 65 through its proximal and distal portions to provide fluid communication between the inlet tube 24 and the hollow tube 43. The inlet fitting proximal end portion 54 includes a counterbore 66 having a side wall diametrically larger than the inlet fitting passageway 65 to define a transverse shoulder 67 extending radially outward from the longitudinally-extending side wall of the passageway 65.

A pair of tube clamps, such as crimped metal ferrules 70 and 71, are disposed circumferentially around the respective ends of the hollow tube 43 and inlet tube 24 and fixedly hold them onto the fitting proximal and distal end portions 54 and 55, respectively. The length of the complete inline filter 20 can be selectively sized by changing the length of the inlet and outlet tubes 24 and 25. Typically, the overall length of the inline filter 20 is between 6 and 36 inches.

The downstream outlet fitting 51 connects the outlet tube proximal end 35 to the hollow tube 43 at its downstream end and includes a body 73 having an upstream large diameter proximal end portion 74 and a downstream small diameter distal stem end portion 75. The fitting proximal end portion 74 has an outer surface and a radially-extending circumferential external rib, or barb 77, projecting from the outer surface including a tapered camming surface 78 facing toward the upstream proximal end and a shoulder 79 facing toward the downstream distal end. The hollow tube outlet end 48 is slidably positioned over the fitting proximal end portion 74 and the camming surface 78 with the barb 77 internally engaging the hollow tube side wall 44 to frictionally hold the hollow tube 43 in position thereon. The fitting distal end portion 75 has an outer surface and a radially extending barb 81 projecting from the outer surface including a tapered camming surface facing toward the downstream distal end and a shoulder 83 facing the upstream proximal end. The outlet tube proximal end 35 is slidably positioned over the outlet fitting distal end portion 75 and the camming surface 82 with the barb 81 internally engaging the outlet tube side wall 37 to frictionally hold the outlet tube 25 in position thereon.

The outlet fitting 51 defines a passageway 85 through its proximal and distal portions to provide fluid communication between the hollow tube 43 and the outlet tube 25. The outlet fitting proximal end portion 74 includes a counterbore 86 having a side wall diametrically larger than the outlet fitting passageway 85 to define a transverse shoulder 87 extending radially outward from the longitudinally-extending side wall of the passageway 85.

A second pair of tube clamps, such as crimped metal ferrules 90 and 91, are disposed circumferentially around the ends of the hollow tube 43 and outlet tube 25 and fixedly hold them onto the fitting proximal and distal end portions 74 and 75, respectively.

Filtering media 95, such as nylon or mesh or fluff, is packed, folded or otherwise disposed within the hollow tube 43. This primary filtering media is pervious to fluid flow and impervious to particles larger than a first determined size to prevent larger particles from moving from the inlet tube 24 downstream to the outlet tube 25. The typical length of the filter body 23 is about 3 inches with the inlet and outlet fittings 50 and 55 occupying about 1½ inches leaving 1½ inches for the filtering media. Depending on the filtering media and the quality of filtering desired, the amount of filtering media can be reduced or enlarged by changing the length of the filter body. Other materials can be employed to physically filter water by removing particulates or to chemically filter water to remove bad odors, tastes, etc. Such filter media might include polyester fibers, fiberfill, packed string, paper elements, plastic mesh, sintered plastic beads or open cell foam depending on what the filtering requirements are, such as whether particulates are to be strained, whether objectionable odors and tastes are to be removed, or any other objectives are desired.

Secondary filtering media 96, such as sintered bronze, is disposed within the outlet fitting counterbore 86 and is pervious to fluid flow and impervious to particles larger than a second determined size smaller than the first predetermined size for the first filtering media to prevent smaller particles from moving from the inlet tube downstream to the outlet tube. Other materials can be used as a final filter media including activated carbon, ceramic, paper, or plastic or metal mesh.

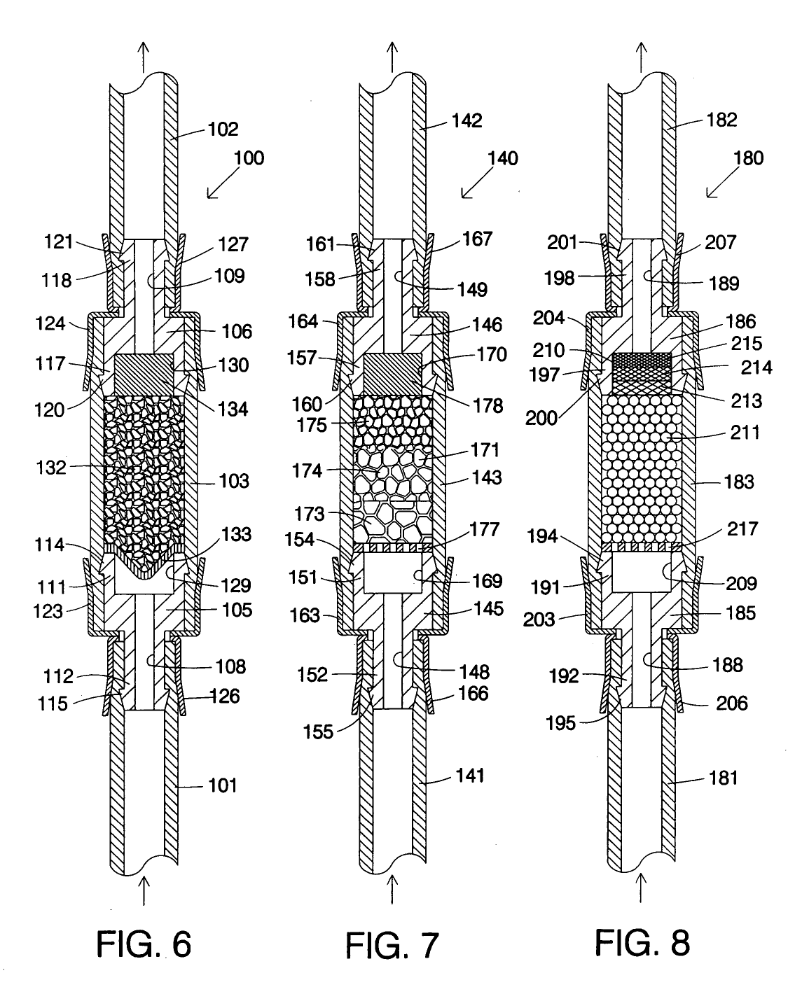

Referring to FIG. 6, a second embodiment of the invention is shown. The inline filter, generally designated 100, includes elongate flexible inlet and outlet connecting tubes 101 and 102 defining respective fluid passageways and an intermediate flexible hollow filter body 103 joined together by a pair of dual-diameter connecting fittings 105 and 106 each defining flow passageways 108 and 109, respectively, therethrough. The inlet connecting fitting 105 has respective proximal and distal ends 111 and 112 with external cammed circumferential barbs 114 and 115, respectively. The outlet connecting fitting 106 has proximal and distal ends 117 and 118 with external circumferential cammed barbs 120 and 121, respectively. The ends of the filter body 103 are affixed to the fittings 105 and 106 by crimped ferrules 123 and 124 and the proximal ends of the inlet and outlet tubes 101 and 102 are affixed to the respective fittings 105 and 106 by crimped ferrules 126 and 127, respectively. The inlet and outlet tubes have connectors (not shown) at their free ends (not shown) for attachment respectively to a fluid source and a fluid delivery point.

Herein, the inlet and outlet fittings 105 and 106 each have respective counterbores 129 and 130 along their respective axial passageways 108 and 109 at their proximal ends. This construction permits a single construction to be employed at both ends of the filter body and permits additional filtering media to be employed upstream of the primary filtering media.

In FIG. 6, the primary filtering media 132 is a scattered array of generally uniformly sized particles made up of carbon granules, gravel, sand, or similar materials. A cone-shaped barrier filter 133 with large perforations or mesh allowing fluid flow therethrough prevents movement of the filtering media within the filter body 103. The cone faces into the upstream counterbore 129 to provide more surface area and minimize clogging. Moreover, sediment will be washed from the top of the cone downstream to the edges. Secondary filtering media 134 of sintered bronze is disposed in the counterbore 130 of the outlet fitting 106. Activated carbon can also be used as a filtering media.

Referring to FIG. 7, a third embodiment of the invention is shown. The inline filter, generally designated 140, includes elongate flexible inlet and outlet connecting tubes 141 and 142 defining respective fluid passageways and an intermediate flexible hollow filter body 143 joined together by a pair of dual-diameter connecting fittings 145 and 146 each defining flow passageways 148 and 149, respectively, therethrough. The inlet connecting fitting 145 has respective proximal and distal ends 151 and 152 with external cammed circumferential barbs 154 and 155, respectively. The outlet connecting fitting 146 has proximal and distal ends 157 and 158 with external circumferential cammed barbs 160 and 161, respectively. The ends of the filter body 143 are affixed to the fittings 145 and 146 by crimped ferrules 163 and 164 and the proximal ends of the inlet and outlet tubes 141 and 142 are affixed to the respective fittings 145 and 146 by crimped ferrules 166 and 167, respectively. The inlet and outlet fittings 145 and 146 each have respective counterbores 169 and 170 along their respective axial passageways 148 and 149 at their proximal ends.

In FIG. 7, the filtering media 171 is comprised of particles or material, or granules, which vary in size from a large size at the upstream end of the filter body 143 to a smaller size at the downstream end of the filter body 143. Herein, three layers of particles 173, 174 and 175 form a longitudinal series, each layer having particles of similar size, each layer thereby having a differing porosity with the downstream layer 175 being impervious to smaller particulate and the upstream layer 173 only being impervious to larger particulate. A perforated barrier filter 177 is placed between the filtering media 171 and the inlet fitting 145 to maintain the filtering media 171 within the filter body 143. Second filtering media 178 of sintered bronze is disposed in the counterbore 170 of the outlet fitting 146.

Referring to FIG. 8, a fourth embodiment of the invention is shown. The inline filter, generally designated 180, includes elongate flexible inlet and outlet connecting tubes 181 and 182 defining respective fluid passageways and an intermediate flexible hollow filter body 183 joined together by a pair of dual-diameter connecting fittings 185 and 186 each defining flow passageways 188 and 189, respectively, therethrough. The inlet connecting fitting 185 has respective proximal and distal ends 191 and 192 with external cammed circumferential barbs 194 and 195, respectively. The outlet connecting fitting 186 has proximal and distal ends 197 and 198 with external circumferential cammed barbs 200 and 201, respectively. The ends of the filter body 183 are affixed to the fittings 185 and 186 by crimped ferrules 203 and 204 and the proximal ends of the inlet and outlet tubes 181 and 182 are affixed to the respective fittings 185 and 186 by crimped ferrules 206 and 207, respectively. The inlet and outlet fittings 185 and 186 each have respective counterbores 209 and 210 along their respective axial passageways 188 and 189 at their proximal ends.

In FIG. 8, the primary filtering media 211 is a series of plastic beads or balls or spherical objects and the secondary filtering media is a series of three stacked mesh filters 213, 214 and 215. The beads may be uniform in size or shape and arranged in a uniform array, but they need not be. The filters 213, 214 and 215 are positioned in the counterbore 210 of the outlet fitting 186 and may vary in mesh spacing or sieve size with the upstream screen having a large spacing and the downstream a smaller spacing so that each screen layer is impervious to different sized impurities. More or less screens may be employed in making up the series of filtering media and the porosity may be varied as the application requires. The balls are held within the filter body by a perforated foraminous barrier filter 217 downstream from the inlet fitting 185 and upstream of the balls. It should be noted that the barrier filter may function as an additional filter and may be optionally positioned within the upstream fitting counterbore 209.

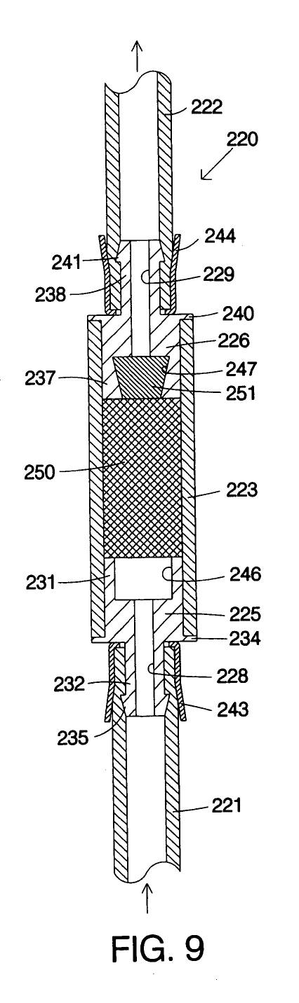

Referring to FIG. 9, a fifth embodiment of the invention is shown. The inline filter, generally designated 220, includes elongate flexible inlet and outlet connecting tubes 221 and 222 defining respective fluid passageways and an intermediate flexible hollow filter body 223 joined together by a pair of dual-diameter connecting fittings 225 and 226 defining flow passageways 228 and 229, respectively, therethrough. The inlet connecting fitting 225 has a proximal end 231 with an external circumferential rib 234 and a distal end 232 with an external cammed circumferential barb 235. The outlet connecting fitting 226 has a proximal end 237 with an external circumferential rib 240 and a distal end 238 with an external circumferential cammed barb 241. The ends of the filter body 223 abut the ribs 234 and 240 and are affixed to the respective proximal ends of the fittings 225 and 226. The proximal ends of the inlet and outlet tubes 221 and 222 are affixed to the respective fittings 225 and 226 by crimped ferrules 243 and 244, respectively. The inlet and outlet fittings 225 and 226 each have respective counterbores 246 and 247 along their respective axial passageways 228 and 229 at their proximal ends.

The filter body 223 may be PVC pipe positioned between the abutting ribs 234 and 240 of the respective fittings and affixed thereto by adhesive or other means. The filter body 223 may also be copper pipe soldered to metal fittings or otherwise joined by suitable means.

In FIG. 9, the primary filtering media 250 is nylon or mesh or fluff, which is packed, folded or otherwise disposed within the filter body 223. The secondary filtering media 251 disposed within the counterbore 247 of the outlet fitting 226 is sintered bronze. Herein, another construction of the counterbore is shown, the counterbore having a relatively small diameter proximal end and a relatively large diameter distal end.

It should be apparent that the filtering media employed within the filter body might be polyethylene, polypropylene, polyester or nylon mesh or natural or man-made fibers or cloth packed into the enlarged filter body. Perforated metal or plastic plates can be substituted for the sintered bronze or screen mesh.

### Industrial Applicability

From the foregoing, it should be apparent the inline filter described herein is simple, compact and inexpensive, yet is a convenient and reliable item.

Other aspects, objects and advantages of this invention can be obtained from a study of the drawings, the disclosure and the appended claims.

1. An inline filter assembly comprising:
an elongate flexible inlet connecting tube having a proximal end and a distal end and a side wall defining a longitudinal flow passage therebetween;
an elongate flexible outlet connecting tube having a proximal end and a distal end and a side wall defining a longitudinal flow passage therebetween;
an intermediate filter body including an elongate hollow tube having a side wall defining a flow passage along a longitudinal axis with an inlet and an outlet at respective upstream and downstream ends spaced along said longitudinal axis;
a first fitting for connecting said inlet tube proximal end to said filter body at its upstream end, said first fitting having a relatively small diameter upstream distal end portion and a relatively large diameter downstream proximal end portion, said filter body inlet being positioned over said first fitting proximal end portion and having an internal diameter generally corresponding thereto, said inlet tube proximal end being positioned over said first fitting distal portion and having an internal diameter generally corresponding thereto, said first fitting defining a passageway therethrough extending between its distal and proximal portions to provide fluid communication between said inlet tube and said filter body;
a second fitting for connecting said outlet tube proximal end to said filter body at its downstream end, said second fitting having a relatively large diameter upstream proximal end portion and a relatively small diameter downstream distal end portion, said filter body outlet being positioned over said second fitting proximal end portion and having an internal diameter generally corresponding thereto, said outlet tube proximal end being positioned over said second fitting distal portion and having an internal diameter generally corresponding thereto, said second fitting defining a passageway therethrough extending between its proximal and distal portions to provide fluid communication between said filter body and said outlet tube; and,
filter media disposed within said filter body for removing impurities from fluid flowing therethrough.

2. The inline filter of claim 1 wherein the internal diameter of the passageway of at least one on said fittings is relatively larger near its proximal end than at its distal end.

3. The inline filter of claim 2 further including second filter media disposed in one of said fittings within its passageway larger diameter portion for removing impurities from fluid flowing therethrough.

4. The inline filter of claim 1 further including second filter media disposed in the passageway of one of said fittings.

5. The inline filter of claim 4 wherein one of said filters physically removes solid impurities from fluid flowing therethrough.

6. The inline filter of claim 4 wherein one of said filters chemically purifies fluid flowing therethrough.

7. The inline filter of claim 4 wherein said first filter media is pervious to fluid flow and impervious to impurities larger than a first determined size to prevent larger impurities from moving from said inlet tube downstream to said outlet tube, and said second filter media is positioned downstream of said first filter media and is impervious to impurities larger than a second determined size smaller than said first predetermined size to prevent smaller impurities from moving from said inlet tube downstream to said outlet tube.

8. The inline filter of claim 4 wherein said first filter media is an array of filtering particles.

9. The inline filter of claim 8 further including a fluid pervious barrier filter positioned between said array of filtering particles and one of said fittings for maintaining said filtering particles within said filter body.

10. The inline filter of claim 4 wherein said second filter media is sintered bronze.

11. The inline filter of claim 4 wherein one of said filter media is a longitudinal series of at least two filter elements for removing impurities from fluid flowing therethrough, each filter element having a differing porosity with a downstream filter element being impervious to smaller impurities than an upstream filter element.

12. The inline filter of claim 11 wherein said series of filters is a longitudinal series of particulate layers, each layer having particulate of a size relatively different from the particulate of an adjacent layer whereby each layer is impervious to different sized impurities.

13. The inline filter of claim 11 wherein said series of filters is a longitudinal series of screens, each screen having a different size mesh whereby each screen is impervious to different sized impurities.

14. The inline filter of claim 1 further including second filter media disposed between said first fitting and said first filter media for removing impurities from fluid flowing therethrough.

15. An inline filter assembly comprising:
an elongate flexible inlet connecting tube having a proximal end and a distal end and a side wall defining a longitudinal flow passage therebetween;
an elongate flexible outlet connecting tube having a proximal end and a distal end and a side wall defining a longitudinal flow passage therebetween;
an intermediate filter body including an elongate hollow tube having a side wall defining a flow passage along a longitudinal axis with an inlet and an outlet at respective upstream and downstream ends spaced along said longitudinal axis;
a first fitting for connecting said inlet tube proximal end to said filter body at its upstream end, said first fitting having a relatively small diameter upstream distal end portion and a relatively large diameter downstream proximal end portion, said filter body inlet being positioned over said first fitting proximal end portion and having an internal diameter generally corresponding thereto, said inlet tube proximal end being positioned over said first fitting distal portion and having an internal diameter generally corresponding thereto, said first fitting defining a passageway therethrough extending between its distal and proximal portions to provide fluid communication between said inlet tube and said filter body with the internal diameter of said passageway being relatively larger near its proximal end than at its distal end;
a second fitting for connecting said outlet tube proximal end to said filter body at its downstream end, said second fitting having a relatively large diameter upstream proximal end portion and a relatively small diameter downstream distal end portion, said filter body outlet being positioned over said second fitting proximal end portion and having an internal diameter generally corresponding thereto, said outlet tube proximal end being positioned over said second fitting distal portion and having an internal diameter generally corresponding thereto, said second fitting defining a passageway therethrough extending between its proximal and distal portions to provide fluid communication between said filter body and said outlet tube with the internal diameter of said passageway being relatively larger near its proximal end than at its distal end; and,
filter media disposed within said filter body for removing impurities from fluid flowing therethrough.

16. The inline filter of claim 15 further including an external rib extending radially outward from each of said fitting distal end portions for limiting relative longitudinal movement of said connecting tubes over the external surface of said fittings, each of said external ribs having a camming surface facing the distal end of said fittings, and said connecting tubes being sufficiently resilient to facilitate longitudinal positioning of said connecting tubes onto the fitting distal end portions over said ribs.

17. The inline filter of claim 16 further including a pair of tube clamps, one of said clamps being circumferentially positioned over each of said connecting tubes near its respective proximal end to hold said connecting tubes on the distal end portions of said fittings.

18. The inline filter of claim 15 further including an external rib extending radially outward from each of said fitting proximal end portions for limiting relative longitudinal movement of said filter body over the external surface of said fittings.

19. The inline filter of claim 18 wherein each of said external ribs has a camming surface facing the proximal end of said fittings, said filter body being flexible and sufficiently resilient to facilitate longitudinal positioning of said filter body onto the fitting proximal end portions over said ribs.

20. The inline filter of claim 19 further including a pair of tube clamps, one of said clamps being circumferentially positioned over said filter body near each end thereof to hold said filter body on the proximal end portions of said fittings.

21. An inline filter assembly comprising:
an elongate flexible inlet connecting tube having a proximal end and a distal end and a side wall defining a longitudinal flow passage therebetween;
an elongate flexible outlet connecting tube having a proximal end and a distal end and a side wall defining a longitudinal flow passage therebetween;
an intermediate filter body including an elongate flexible hollow tube having a side wall defining a flow passage along a longitudinal axis with an inlet and an outlet at respective upstream and downstream ends spaced along said longitudinal axis;
a first fitting for connecting said inlet tube proximal end to said filter body at its upstream end, said first fitting having a relatively small diameter upstream distal end portion and a relatively large diameter downstream proximal end portion, said filter body inlet being positioned over said first fitting proximal end portion and having an internal diameter generally corresponding thereto, said inlet tube proximal end being positioned over said first fitting distal portion and having an internal diameter generally corresponding thereto, said first fitting defining a passageway therethrough extending between its distal and proximal portions to provide fluid communication between said outlet tube and said filter body with the internal diameter of said passageway being relatively larger near its proximal end than at its distal end;
a second fitting for connecting said outlet tube proximal end to said filter body at its downstream end, said second fitting having a relatively large diameter upstream proximal end portion and a relatively small diameter downstream distal end portion, said filter body outlet being positioned over said second fitting proximal end portion and having an internal diameter generally corresponding thereto, said outlet tube proximal end being positioned over said second fitting distal portion and having an internal diameter generally corresponding thereto, said second fitting defining a passageway therethrough extending between its proximal and distal portions to provide fluid communication between said filter body and said outlet tube with the internal diameter of said passageway being relatively larger near its proximal end than at its distal end;
an external rib extending radially outward from each of said fitting proximal end portions for limiting relative longitudinal movement of said filter body over the external surface of said fittings, each of said external ribs having a camming surface facing the proximal end of said fittings, said filter body being sufficiently resilient to facilitate longitudinal positioning of said filter body onto the fitting proximal end portions over the proximal end ribs;
a first pair of tube clamps, one clamp being circumferentially positioned over said filter body near each end thereof to hold said filter body on the distal end portions of said fittings;
an external rib extending radially outward from each of said fitting distal end portions for limiting relative longitudinal movement of said connecting tubes over the external surface of said fittings, each of said external ribs having a camming surface facing the distal end of said fittings, said connecting tubes being sufficiently resilient to facilitate longitudinal positioning of said connecting tubes onto said fitting distal end portions over the distal end ribs;
a second pair of tube clamps, one of said second clamps being circumferentially positioned over each of said connecting tubes near its respective proximal end to hold said connecting tubes on the distal end portions of said fittings; and,
filter media disposed within said filter body for removing impurities from fluid flowing therethrough.

22. The inline filter of claim 21 further including second filter media disposed in one of said fittings within its passageway larger diameter portion for removing impurities from fluid flowing therethrough.
